(19) United States
(12) Patent Application Publication
(10) Pub. No.: US 2014/0343937 A1
(43) Pub. Date: Nov. 20, 2014

(54) INTERRUPT MODE FOR COMMUNICATION APPLICATIONS

(71) Applicant: VOXER IP LLC, San Francisco, CA (US)

(72) Inventors: Thomas E. KATIS, Jackson, WY (US); James T. PANTTAJA, San Francisco, CA (US); Mary G. PANTTAJA, San Francisco, CA (US); Matthew J. RANNEY, Oakland, CA (US)

(21) Appl. No.: 13/909,004

(22) Filed: Jun. 3, 2013

Related U.S. Application Data
(60) Provisional application No. 61/824,323, filed on May 16, 2013.

(51) Int. Cl. H04L 12/58; G10L 15/26; G10L 13/00

(52) U.S. Cl. CPC H04L 51/18; G10L 13/00; G10L 15/26
USPC 704/235; 704/260; 709/206

(57) ABSTRACT

An interrupt mode for messaging applications intended to run on smart phones, tablets and computers. The interrupt mode enables the automatic rendering of incoming messages, in accordance with various embodiments, when (i) the application is closed, (ii) the conversation for which the message pertains has not been selected for participation, (iii) the interrupt mode has been designated for the sender of the message or (iv) any combination of (i) through (iii). When a message is rendered in the interrupt mode, the media of the message is automatically rendered. As a result, the user of the communication device is interrupted.

### RELATED APPLICATIONS

This application claims the benefit of priority to U.S. Provisional Patent Application No. 61/824,323, filed on May 16, 2013, entitled “Interrupt Mode For Communication Applications”, incorporated by reference herein for all purposes.

### BACKGROUND

1. Field of the Invention

The present invention relates to communications, and more particularly, to an interrupt mode for messaging applications intended to run on smart phones, tablets and other communication devices.

2. Description of Related Art

In recent years, mobile communications and computing has become very popular. More and more people are using mobile communication devices, such as smart phones and tablets, for a variety of reasons, including messaging. With messaging, the user of the smart phone or tablet is typically required to download an application that runs on the device. When in use, the messaging application typically allows the user to create one or more conversations with remote users of the same application and to send and receive messages within the context of the one or more conversations respectfully.

One issue with the above-mentioned messaging applications is that typically an incoming message is automatically rendered only when (i) the application is open on the device and (ii) the conversation for which incoming message pertains has been selected for participation. For example, if the application is closed, or the recipient is participating in a first conversation when a message is received pertaining to a second conversation, then the recipient is typically only notified of the receipt of the incoming message. The incoming message, however, is not rendered when it is received in these circumstances.

### SUMMARY OF THE INVENTION

The present invention is directed to an interrupt mode for messaging applications intended to run on smart phones, tablets and computers. The interrupt mode enables the automatic rendering of incoming messages, in accordance with various embodiments, when (i) the application is closed, (ii) the conversation for which the message pertains has not been selected for participation, (iii) the interrupt mode has been designated for the sender of the message or (iv) any combination of (i) through (iii). When a message is rendered in the interrupt mode, the media of the message is automatically rendered. As a result, the user of the communication device is interrupted.

In a non-exclusive embodiment, if there are a plurality of messages to be rendered in the interrupt mode at approximately the same time, the plurality of messages are placed in a queue and rendered out of the queue. In variations of this embodiment, the messages in the queue may be rendered in a first-in, first-out order, or alternatively, in accordance with a predefined priority scheme.

In other non-exclusive embodiments, the received media rendered in the interrupt mode may include, but is not limited to, voice, text, photos, video, GPS or positional data, or any other type of media.

In yet other embodiments, the interrupt mode may be used for Push-to-Talk (PTT) messaging applications, or any other communication application capable of transmitted and/or receiving media in the form of messages.

### BRIEF DESCRIPTION OF THE DRAWINGS

The invention may best be understood by reference to the following description taken in conjunction with the accompanying drawings, which illustrate specific embodiments of the invention.

FIG. 1 is a block diagram of a non-exclusive embodiment of a communication device configured to run a messaging application in accordance with the principles of the present invention.

FIG. 2A is an exemplary flow chart of a non-exclusive embodiment illustrating the steps for implementing an interrupt mode for a messaging application in accordance with the principles of the present invention.

FIG. 2B is an exemplary flow chart of another non-exclusive embodiment illustrating the steps for implementing an interrupt mode for a messaging application in accordance with the principles of the present invention.

FIG. 2C is an exemplary flow chart of a non-exclusive embodiment illustrating the steps for implementing an interrupt mode for a messaging application in accordance with the principles of the present invention.

FIG. 2D is an exemplary flow chart of another non-exclusive embodiment illustrating the steps for implementing an interrupt mode for a messaging application in accordance with the principles of the present invention.

FIG. 3 is a diagram illustrating a first embodiment of the operation of the interrupt mode in accordance with the principles of the present invention.

FIGS. 4A and 4B are diagrams illustrating additional embodiments of the operation of the interrupt mode in accordance with the principles of the present invention.

FIG. 5 is a diagram illustrating another embodiment of the operation of the interrupt mode in accordance with the principles of the present invention.

FIG. 6 is a diagram illustrating yet another embodiment of the operation of the interrupt mode in accordance with the principles of the present invention.

FIG. 7 is a diagram illustrating yet another embodiment of the interrupt of the interrupt mode in accordance with the principles of the present invention.

FIG. 8 is a diagram illustrating yet another embodiment of the interrupt of the interrupt mode in accordance with the principles of the present invention.

It should be noted that like reference numbers refer to like elements in the figures.

The above-listed figures are illustrative and are provided as merely examples of embodiments for implementing the various principles and features of the present invention. It should be understood that the features and principles of the present invention may be implemented in a variety of other embodiments and the specific embodiments as illustrated in the Figures should in no way be construed as limiting the scope of the invention.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obstruct the invention.

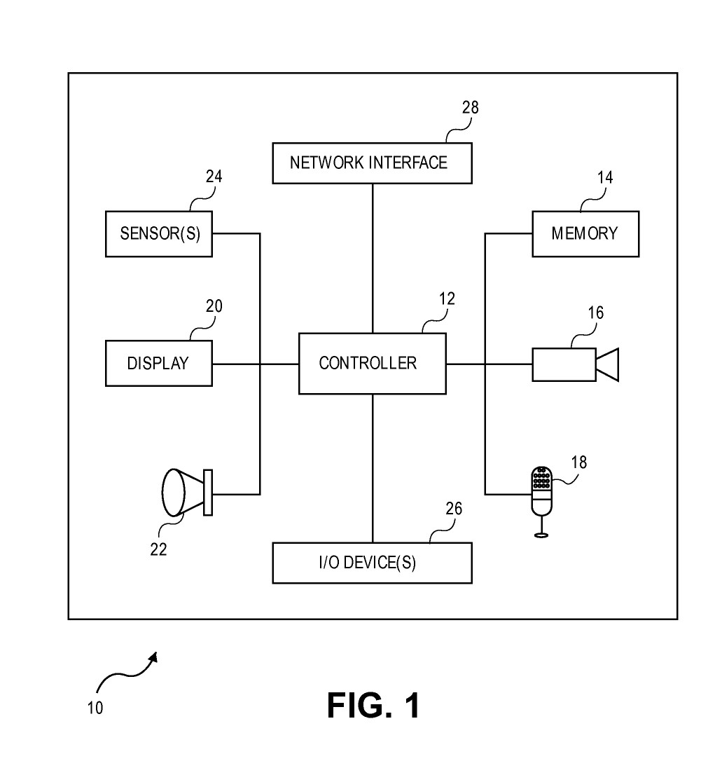

Referring to FIG. 1, a block diagram of a non-exclusive embodiment of a communication device 10 configured to run a messaging application in accordance with the principles of the present invention is shown. The communication device 10 includes a controller 12, memory 14, a still and/or video camera 16, a microphone 18, a display 20 which may optionally be touch-sensitive, a speaker 22, one or more sensors 24, such as but not limited to a GPS or a positional sensing element, a temperature sensing element, or any other type of element capable of sensing data, one or more input/output (I/O) devices 26, such as a physical keyboard or a virtual keyboard which operates in cooperation with display 20, scroll button(s), push button(s), a headset, etc., and a network interface 28, which is provided to connect the device 10 to a wired or wireless network. As the operation of all of the elements 12 through 28 are well known, a detailed explanation is not provided herein.

In one embodiment, the device 10 may be a mobile device, such as a smart phone or tablet. For example, the device 10 may be a mobile phone or tablet such as those designed for the iOS by Apple, Android by Google, or similar operating systems by Blackberry, Microsoft, or any other operating system platform. In an alternative embodiment, the device 10 can be a desktop or laptop computer running the messaging application, either through a Web browser or as a native application.

The communication device 10 is configured to run the messaging application, which is implemented in computer code, stored in memory 14, and executed by the controller 12. The user interacts with the messaging application using the elements 16 through 28 in a well-known manner. In various embodiments, the messaging application may be capable of transmitting and/or receiving messages containing one or more of the following types of media, including voice, text, photos, video, GPS or positional data, or any other type of media.

For the sake of illustration, the present invention is described within the context of the Voxer® Walkie Talkie PTT messaging application, distributed by the assignee of the present application. Voxer is a progressive, store and forward, messaging application designed to operate on smart phones, tablets and computers. As a progressive application, outgoing “Vox” messages are progressively stored and progressively transmitted by the sending device as the media of the message is created. Incoming Vox messages are also progressively stored on a receiving device as the media is received over the network. With the progressive processing and storage of media, Voxer allows users to selectively render incoming Vox messages in either near real-time as the media is received over the network or in a time-shifted mode by rendering the message out of storage. Voxer also has the ability to allow users to create and participate in one or more conversations with other Voxer users by semantically threading together the exchanged Vox messages between two or more persons (i.e., a group) sharing a common attribute. With the storage of messages threaded together into conversations, the users of Voxer can transition between conversation for participation and have the ability to review the history of each of the conversations when convenient. Voxer is also capable of operating in both a half-duplex and a full-duplex mode. In other words, a communication device running Voxer is capable of both sending and receiving Vox messages at the same time. In situations when two Vox users are sending and rendering received messages from one another at substantially the same time, the user experience is similar to that of a conventional, synchronous, telephone call. On the other hand when the two users are sending messages back and forth at discrete times, then the user experience is similar to asynchronous messaging. Yet another advantage of Voxer is that Vox messages are not limited to voice media. On the contrary, Vox messages may include one or more types of media, including voice, video, text, photos, GPS or positional data, or other sensor data. Finally, Voxer provides the advantages of guaranteed delivery of Vox messages. Besides the progressive storage of Vox messages on transmitting and receiving devices, Voxer also provides for the progressive storage of Vox messages on the network. As a result, messages can be transmitted out of storage by a transmitting device in situations when network conditions are poor or non-existent when the message was created or transmitted out of storage on the network if the recipient was not available when the message was created and transmitted. In addition, Voxer uses transmission protocols that ensure the delivery of complete messages. For more details regarding the Voxer application, see co-pending, commonly assigned, U.S. application Ser. No. 12/037,749, incorporated herein for all purposes.

When the Voxer application is opened, the conversations of a user are displayed. When a conversation is selected for participation, the conversation history, including the sent and received messages of the selected conversation, is displayed. A Voxer user may participate in a selected conversation by rendering received messages in both (i) near real-time as the media of messages is received from other participant(s) over the network and (ii) in a time-shifted mode by selecting and rendering the media associated with one or more previously received or sent messages from storage. A user may also participate by creating and sending messages pertaining to the conversation. Vox messages including voice media may be created and sent by implementing a virtual “Hold-and-Talk” feature appearing on a screen (or an analogous PTT function) on the communication device and speaking into the microphone. As the media of the Vox message is created, the media is progressively stored and progressively transmitted to the other participant(s) of the conversation. Voxer also enables the transmission of other types of messages within a conversation, including text messages, photos, GPS/positional data, and potentially other types of media, such video or sensor data.

Although the Voxer application is described in detail above, it should be understood that the interrupt mode as described herein is by no means limited to the Voxer application. Rather, the interrupt mode as described herein may be implemented on any communication application capable of transmitting and receiving media within the context of a message. In optional embodiments, the messages rendered in the interrupt mode may or may not be part of conversations. Furthermore, the interrupt mode as described herein is intended for messaging applications configured to run on smart phones, tablet computers, laptops, radios, desktop computers, or any other type of wired or wireless communication device. Regardless of the application, or the type of device, the interrupt mode enables the automatic rendering of incoming messages, in accordance with various embodiments, when (i) the application is closed, (ii) the conversation for which the message pertains has not been selected for participation, (iii) the interrupt mode has been designated for the sender of the message or (iv) any combination of (i) through (iii). When a message is rendered in the interrupt mode, the media of the message is automatically rendered. As a result, the user of the communication device is interrupted.

In a non-exclusive embodiment of the interrupt mode, the communication application executes a background process on the communication device. During this background process, any incoming media is stored and associated with the corresponding conversation. In this manner, all incoming messages are received, stored, and associated with the appropriate conversation, even when the application is closed. In an alternative embodiment, the application runs a background process that implements the interrupt mode as described below, but without storing the message and/or associating the incoming message with a particular conversation.

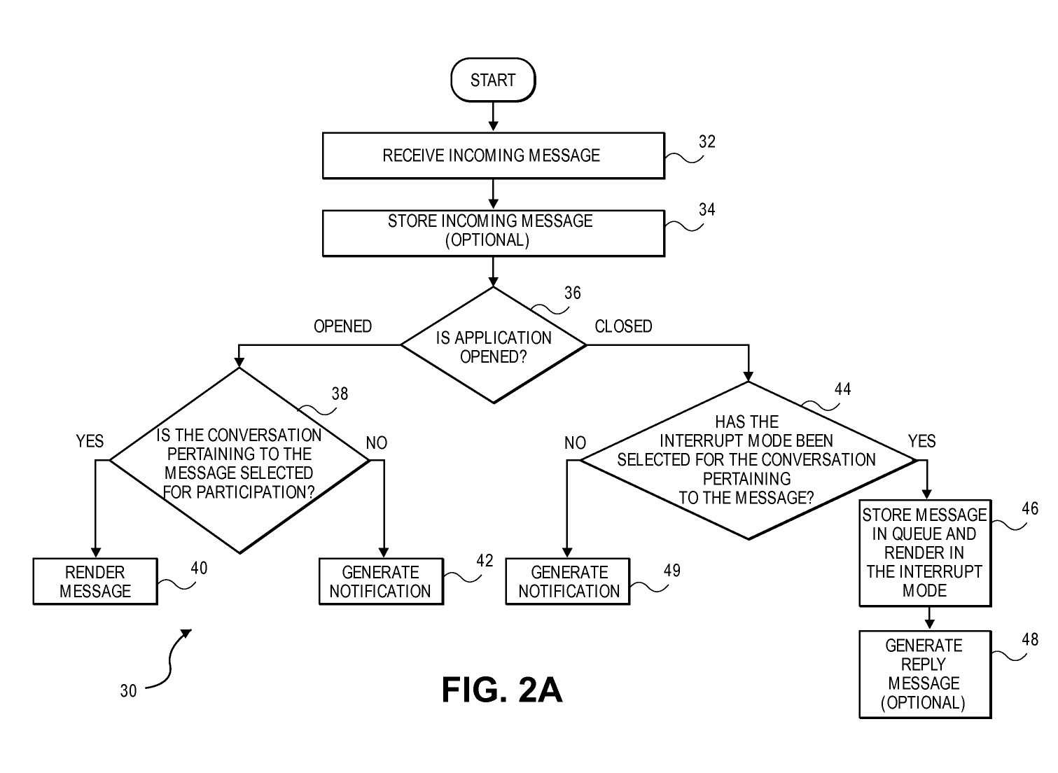

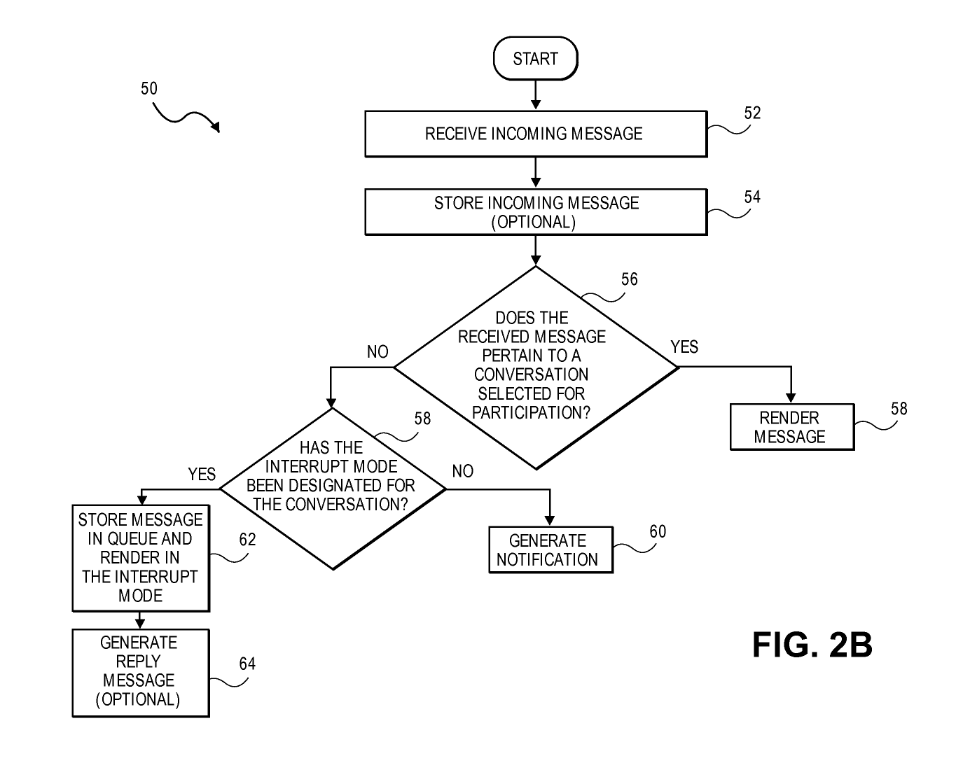

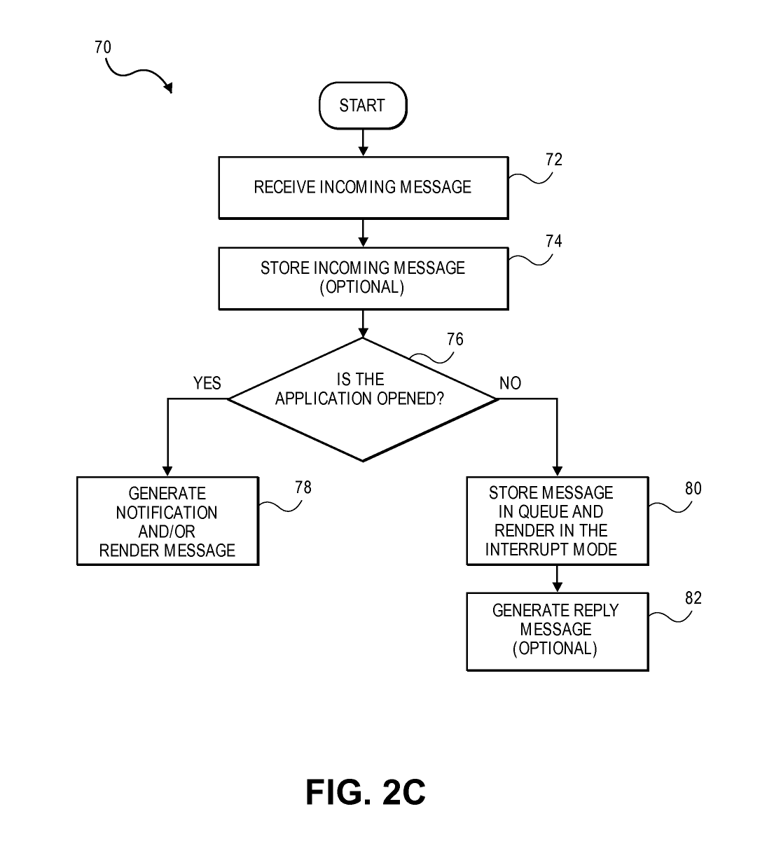

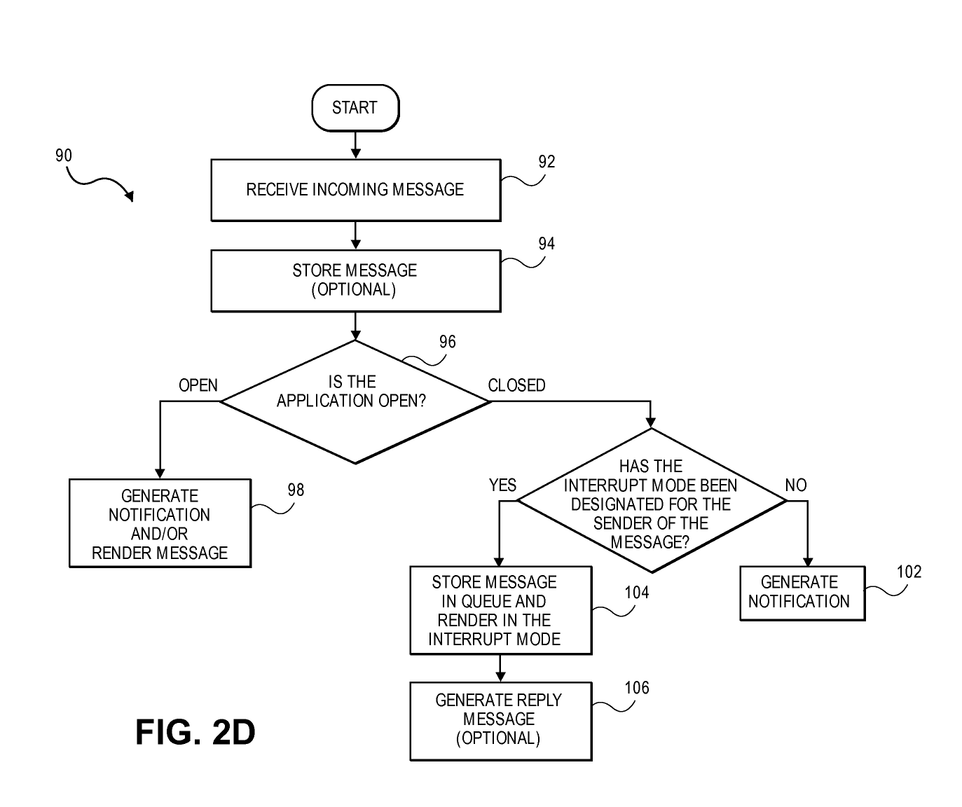

Referring to FIG. 2A, a first non-exclusive embodiment of a flow chart 30 illustrating the steps for implementing an interrupt mode when (i) the application is closed and (ii) the interrupt mode has been activated for the conversation for which an incoming message pertains. In the initial step 32, an incoming message is received and optionally stored in step 34. Next, it is determined if the communication application is opened or closed (decision 36) on the communication device 10. If open, then it is determined if the conversation, pertaining to the received message, is selected for participation or not (decision 38). If selected for participation, then the message is rendered (step 40) as it would ordinarily be for an incoming message pertaining to a conversation selected for participation. If not been selected for participation, then a notification (42) of receipt of the message is generated. On the other hand if the application is closed (decision 36), then it is determined (decision 44) if the interrupt mode has been selected for the conversation pertaining to the message. If yes, then the message is placed in a queue, automatically rendered (step 46) in the interrupt mode, and the recipient may optionally generate a response message (step 48). If the interrupt mode has not been selected for the conversation, then a notification of receipt of the message is generated (step 49).

FIG. 2B illustrates a second non-exclusive embodiment of a flow chart 50 for implementing the interrupt mode on a per conversation basis, regardless if the messaging application is opened or closed. In the initial steps 52 and 54, an incoming message is received and optionally stored on the communication device 10 respectively. In the next step (decision 56), it is determined if the received message pertains to a conversation that the user has selected for participation. If yes, then the message is rendered (step 58) as it ordinary would be for an incoming message pertaining to a conversation selected for participation. If not, then it is determined if the interrupt mode has been designated for the conversation (decision 58). If no, then a notification is generated notifying of receipt of the message (Step 60). If yes, then the message is placed in a queue and automatically rendered in the interrupt mode (step 62) and the recipient may optionally generate a reply message (step 64).

FIG. 2C illustrates another non-exclusive embodiment of a flow chart 70 illustrating the steps for implementing an interrupt mode based solely on if the application is closed. In the initial steps 72 and 74, an incoming message is received and optionally stored on the communication device 10 respectively. Next, it is determined if the communication application is opened or closed (decision 76). If open, then a notification is generated and/or the message is rendered as ordinarily would occur for an incoming message. On the other hand when the application is closed, then the message is placed in a queue and automatically rendered (step 80) in the interrupt mode and the recipient may optionally generate a response message (step 82).

FIG. 2D illustrates another non-exclusive embodiment of a flow chart 90 illustrating the steps for implementing an interrupt mode based on (i) if the application is closed and (ii) the identity of the sender of a message. In the initial steps 92 and 94, the message is received and optionally stored on the communication device 10 respectively. Next, it is determined if the communication application is opened or closed (decision 96). If open, then a notification is generated and/or the message is rendered (step 98) as ordinarily would occur for an incoming message. On the other hand when the application is closed, then it is determined if the interrupt mode has been designated for the sender of the message (decision 100). If no, then a notification is generated notifying of receipt of the message (Step 102). If yes, then the message is placed in a queue and automatically rendered in the interrupt mode (step 104) and the recipient may optionally generate a reply message (step 106).

It is useful to note that messages rendered in the interrupt mode, as explained above with regard to FIGS. 2A-2D, are first placed into a queue to cover the possibility of rendering two or more messages at approximately the same time in the interrupt mode. When this situation occurs, in accordance with various embodiments, the messages may be rendered (i) in the order in which they were received or (ii) in a priority order. For example, the messages in one conversation may have a higher priority than the messages in another conversation. Alternatively, certain senders may be assigned a higher priority than other senders. In either case, higher priority messages in the queue will be rendered ahead of lower priority messages. In situations when there is only one message available for rendering in the interrupt mode, then the message is rendered immediately.

It is also useful to note that the rendering of message in the interrupt mode may or may not occur in near real-time, depending on a number of factors. With progressive messaging applications such as Voxer, an incoming message in the interrupt mode is typically rendered in near real-time, as the media is progressively received over the network and progressively stored on the receiving communication device. If a received message to be rendered in the interrupt mode, however, is not first priority in the queue, then the rendering of the message will be delayed until after the higher priority message(s) is/are rendered. On the other hand with store and forward messaging applications that are not progressive, then incoming media is typically never rendered in near real-time. On the contrary, these messaging applications will typically render messages, including in the interrupt mode, only after the message is received in its entirety. In yet other embodiments, the media of a received message is buffered for rendering as or immediately after the message is received. With these embodiments, rendered media in the buffer is discarded or written over with the contents of another message and is not persistently stored.

In various non-exclusive embodiments, a communication application may selectively implement one or more of the interrupt mode embodiments of FIGS. 2A-2D either separately or concurrently. Depending on which embodiment(s) are selected, the interrupt mode is implemented when (i) the application is closed, (ii) the conversation for which the message pertains has not been selected for participation, (iii) the interrupt mode has been designated for the sender of the message or (iv) any combination of (i) through (iii).

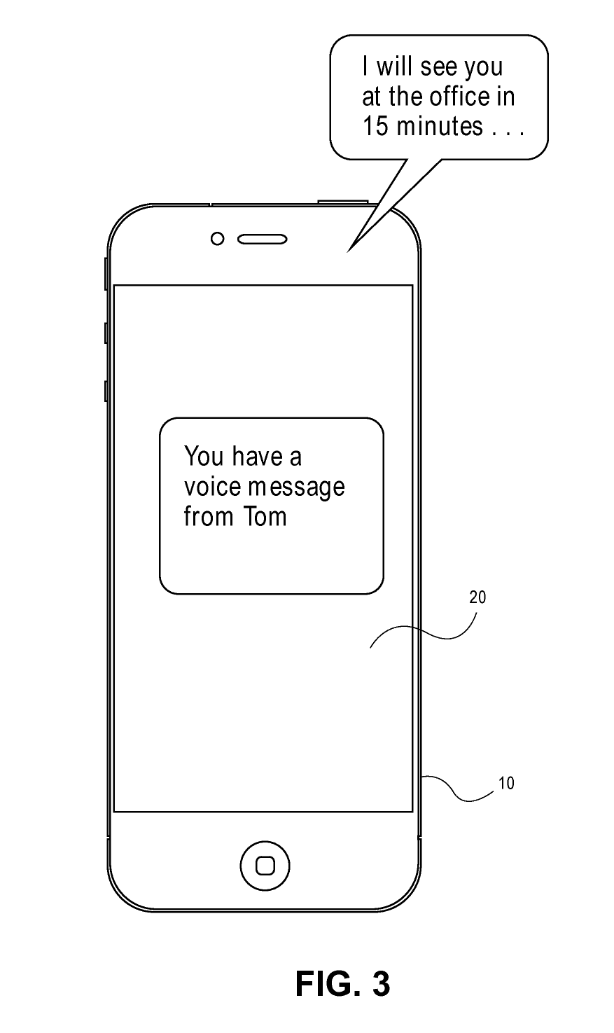

In FIGS. 3, 4A, 4B, 5 and 6, various non-exclusive embodiments for rendering incoming media in the interrupt mode are illustrated.

FIG. 3 shows the rendering of a voice message from a conversation participant named Tom by the speaker 22 on the communication device 10 in the interrupt mode.

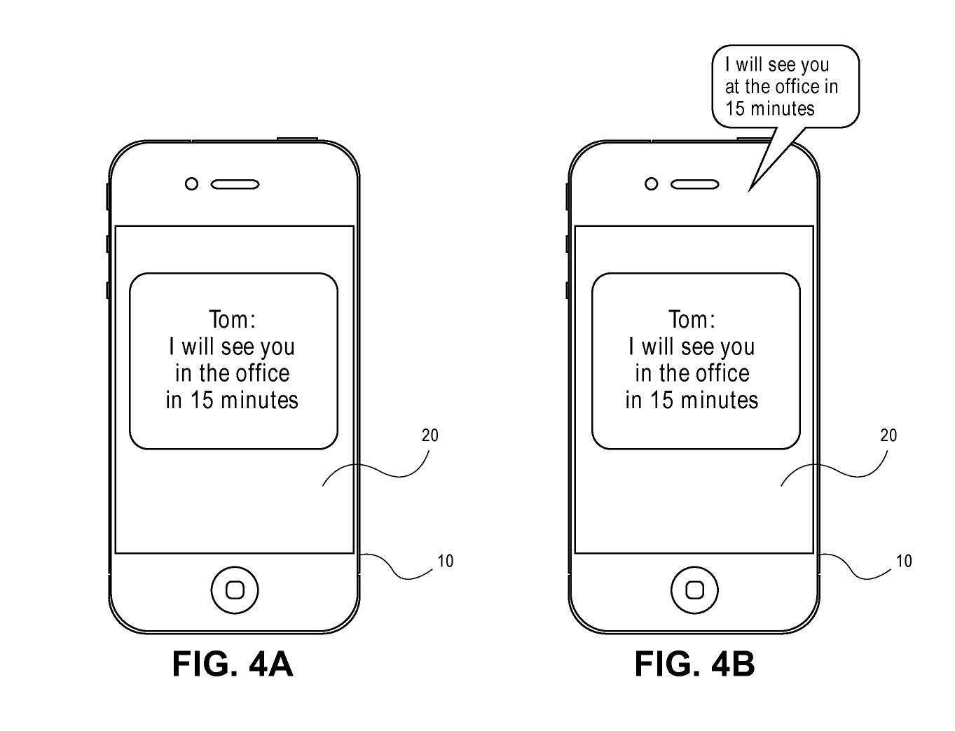

FIG. 4A shows an incoming text message rendered in the interrupt mode on the display 20 of the communication device 10.

FIG. 4B shows a text-to-voice conversion performed in the interrupt mode using conventional text-to-voice conversion software. As illustrated, both the incoming text message is displayed on the display 20 and optionally the voice of the message is rendered on the speaker 22 of the communication device. Alternatively, although not illustrated, a voice-to-text translation may also be performed, resulting in the display of the translated text on display 20 and optionally the rendering of the voice message.

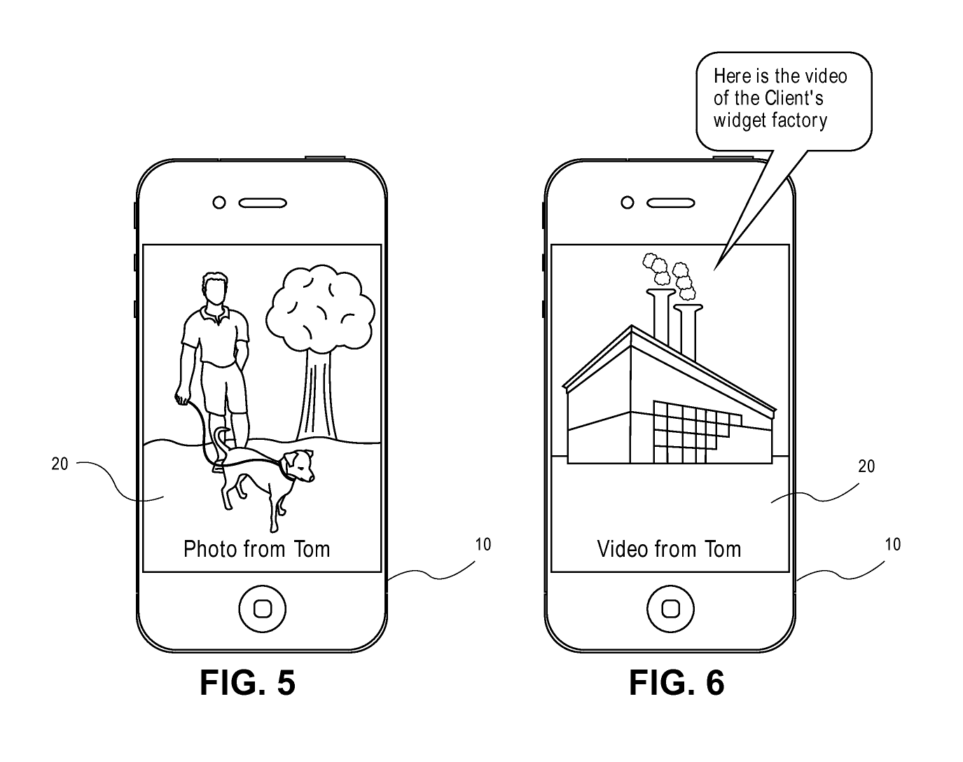

FIG. 5 shows the rendering of a photo or image on the display 20 of communication 10 in the interrupt mode.

FIG. 6 show the rendering of a video on the display 20 and the corresponding audio on speaker 22 of communication 10 in the interrupt mode.

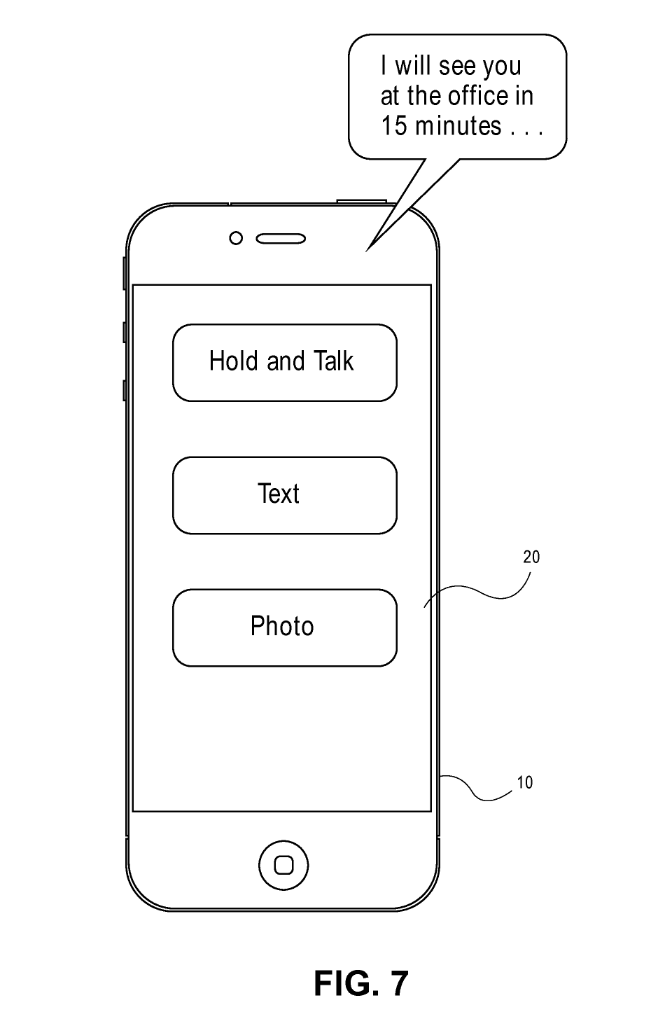

Referring to FIG. 7, an embodiment for optionally generating a reply message in response to the rendering of an incoming message in the interrupt mode is illustrated. In a non-exclusive embodiment, one or more reply widgets are generated on the display 20 in response to a received message rendered in the interrupt mode in accordance with any of the embodiments of FIGS. 2A through 2D. In the example illustrated, separate widgets are provided to enable the recipient to generate a reply voice message with a Hold-and-Talk widget, a reply text message using a Text widget, and/or a photo using the Photo widget. It should be noted that the illustrated widgets are merely exemplary. In alternative embodiments, any hardware or software feature or function on the communication device 10, or a peripheral device such as a headset, mouse, keyboard, video camera, etc., may be used to generate the reply message.

In a real-world example, consider the operation of a smart-phone and headset cooperating to implement the interrupt mode with a messaging application. With the headset, incoming voice messages rendered in the interrupt mode are automatically played through the speaker in the headset. Reply messages are generated by implementing a Talk function on the headset. In this manner, the user can receive and render messages in the interrupt mode, and generate reply messages, with minimal to no use of their hands to control the operation of the device 10 running the messaging application. As a result, the user is free to consume incoming message in the interrupt mode, and to generate reply messages, while performing other tasks.

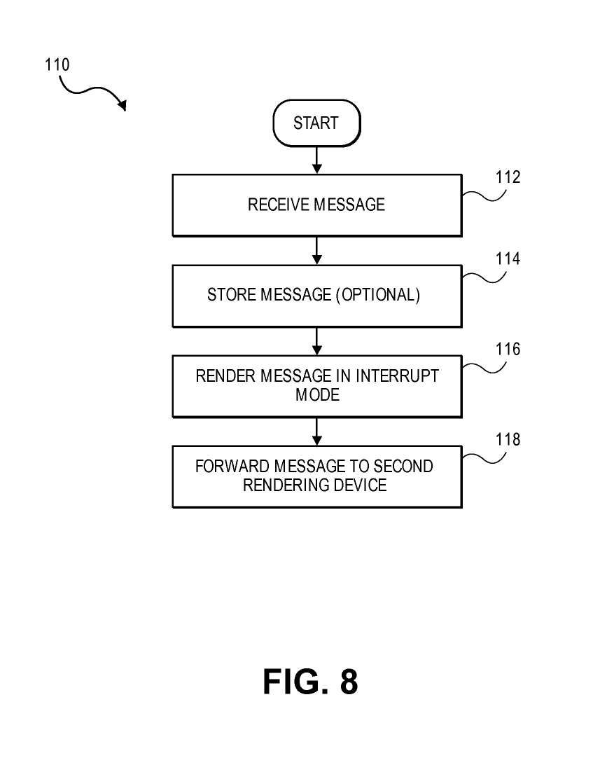

FIG. 8 is a diagram illustrating yet another embodiment of the interrupt mode in accordance with the principles of the present invention. With this embodiment, a received message rendered in the interrupt mode is also rendered on a second (or perhaps multiple) second rendering devices. In this embodiment, a message is received in step 112 and optionally stored in step 114. The message is automatically rendered in step 116 in the interrupt mode in accordance with any of the embodiments of FIGS. 2A-2D discussed above. The message is then forwarded to a second (or multiple) rendering device(s) associated with the recipient. For example, a message received and rendered in the interrupt mode may be forwarded from a user's mobile phone to their tablet or desktop computer. In this way, the user is interrupted with the messages, even in situations when the user is not using or have close access to their mobile phone. It should be noted that the user can designate any second device, or multiple second devices, to receive and render messages in the interrupt mode, such as, but not limited to, another mobile device, tablet, computer, radio, display device, speaker, printer, etc.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and methods and should not be restricted to the ones mentioned above. It is therefore intended that the invention be interpreted to include all variations and equivalents that fall within the true spirit and scope of the invention.

What is claimed is:

1. An application embedded in a non-transitory computer readable medium and intended to run on a communication device configured to be connected to a network, the application configured to:
automatically render a received message in an interrupt mode in accordance with one of the following:
(i) the application is closed when the message is received;
(ii) the message pertains to a conversation not selected for participation;
(iii) the interrupt mode has been designated for a sender of the message; or
(iv) any combination of (i) through (iii).

2. The application of claim 1, further configured to store media associated with the received message on the communication device as the media is received over the network.

3. The application of claim 1, wherein automatically rendering the received message in the interrupt mode further comprises progressively rendering media associated with the received message as the media is progressively received over the network.

4. The application of claim 1, wherein automatically rendering the received message in the interrupt mode further comprises:
receiving media associated with the received message at the communication device;
storing the media associated with the received message on the communication device; and
automatically rendering the received message after the media associated with the message is received and stored on the communication device.

5. The application of claim 1, wherein automatically rendering the received message in the interrupt mode further comprises rendering voice media contained in the message.

6. The application of claim 1, wherein automatically rendering the received message in the interrupt mode further comprises rendering text media contained in the message.

7. The application of claim 1 wherein automatically rendering the received message in the interrupt mode further comprises
performing a text-to-voice translation for text media contained in the received message; and
rendering the translated voice media.

8. The application of claim 1, wherein automatically rendering the received message in the interrupt mode further comprises
performing a voice-to-text translation for voice media contained in the received message; and
rendering the translated text media.

9. The application of claim 1, wherein automatically rendering the received message in the interrupt mode further comprises rendering an image or photo contained in the received message.

10. The application of claim 1, wherein automatically rendering the received message in the interrupt mode further comprises rendering video media contained in the message.

11. The application of claim 1, further configured to queue a plurality of received messages for rendering in the interrupt mode.

12. The application of claim 11, further configured to render the plurality of messages in the queue using one of the following protocols:
(i) first-in, first out;
(ii) by conversation priority; or
(iii) by sender priority.

13. The application of claim 1, wherein the application is a Push-To-Talk (PTT) application and the received message is a PTT message.

14. The application of claim 1, wherein the application is further configured to transmit a reply message created by a user of the communication device in response to the automatic rendering of the received message in the interrupt mode.

15. The application of claim 1, wherein the received message is a voice message that blares out of a headset speaker coupled to the communication device when automatically rendered in the interrupt mode.

16. The application of claim 1, wherein the application is further configured to forward the received message to a second rendering device for rendering on the second communication device.

17. An application embedded in a non-transitory computer readable medium and intended to run on a communication device configured to be connected to a network, the application configured to:
enable a user of the communication device to selectively participate in a conversation;
activate an interrupt mode for the conversation;
store a received voice message pertaining to the conversation on the communication device; and
automatically render the received voice message in the interrupt mode when the conversations is not selected for participation.

18. The application of claim 17, further configured to generate a notification for the received voice message, but not automatically render the received voice message, when the interrupt mode is not activated for the conversation.

19. The application of claim 17, wherein automatically rendering the received voice message in the interrupt mode further comprises progressively rendering voice media associated with the received voice message as the voice media is progressively received at the communication device.

20. The application of claim 17, wherein automatically rendering the received voice message in the interrupt mode further comprises:
receiving voice media associated with the voice message at the communication device;
storing the voice media associated with the voice message on the communication device; and
automatically rendering the received voice message after the voice media associated with the voice message is received and stored on the communication device.

21. The application of claim 17, wherein the voice message blares out of a speaker associated with the communication device when automatically rendered in the interrupt mode.

22. The application of claim 17, wherein the voice message blares out of a headset speaker coupled to the communication device when automatically rendered in the interrupt mode.

23. The application of claim 17, wherein automatically rendering the received voice message in the interrupt mode further comprises:
performing a voice-to-text media translation of voice media included in the received voice message; and
automatically rendering the translated text media.

24. The application of claim 17, further comprising:
receiving a text message pertaining to the conversation at the communication device; and
automatically rendering the text message when the interrupt mode is activated for the conversation.

25. The application of claim 17, further comprising:
receiving a text message pertaining to the conversation at the communication device;
performing a text-to-voice media translation of the received text message; and
automatically rendering the translated voice media.

26. The application of claim 17, further comprising:
receiving a photo or image pertaining to the conversation at the communication device; and
automatically rendering the photo or image when the interrupt mode is activated for the conversation.

27. The application of claim 17, further comprising:
receiving a video message pertaining to the conversation at the communication device; and
automatically rendering the video message when the interrupt mode is activated for the conversation.

28. The application of claim 17, further configured to:
receive a plurality of voice messages for rendering in the interrupt mode;
queue the plurality of voice messages for rendering in the interrupt mode; and
automatically render the voice messages in the queue in the interrupt mode.

29. The application of claim 28, further configured to automatically render the queued voice messages using one of the following:
(i) first-in, first out;
(ii) by conversation priority; or
(iii) by sender priority.

30. The application of claim 17, wherein the application is a Push-To-Talk (PTT) application and the received voice message is a PTT message.

31. The application of claim 17, wherein the application is further configured to transmit a reply message in response to the automatic rendering of the received voice message in the interrupt mode.

32. The application of claim 17, wherein the application is further configured to forward the received voice message to a second rendering device for rendering on the second communication device.

33. The application of claim 17, wherein the application is further configured to activate the interrupt mode for a plurality of conversations.

34. An application embedded in a non-transitory computer readable medium and intended to run on a communication device configured to be connected to a network, the application configured to:
enable a user of the communication device to selectively open or close the application;
enable the user to selectively participate in a conversation when the application is open;
activate an interrupt mode for the conversation; and
automatically render a received voice message pertaining to the conversation in the interrupt mode when (i) the interrupt mode is activated for the conversation and (ii) the application is closed.

35. The application of claim 34, further configured to store voice media associated with the received voice message on the communication device as the voice media is received over the network.

36. The application of claim 34, wherein automatically rendering the received voice message in the interrupt mode further comprises progressively rendering voice media associated with the received voice message as the voice media is progressively received at the communication device.

37. The application of claim 34, wherein automatically rendering the received voice message in the interrupt mode further comprises:
receiving voice media associated with the voice message at the communication device;
storing the voice media associated with the voice messages on the communication device; and
automatically rendering the received voice message after the voice media associated with the voice message is received and stored on the communication device.

38. The application of claim 34, wherein the voice message blares out of a speaker associated with the communication device when automatically rendered in the interrupt mode.

39. The application of claim 34, wherein the voice message blares out of a headset speaker coupled to the communication device when automatically rendered in the interrupt mode.

40. The application of claim 34, wherein automatically rendering the received voice message in the interrupt mode further comprises:
performing a voice-to-text media translation of voice media included in the received voice message; and
automatically rendering the translated text media.

41. The application of claim 34, further comprising:
receiving a text message pertaining to the conversation at the communication device; and
automatically rendering the text message when the interrupt mode is activated for the conversation.

42. The application of claim 34, further comprising:
receiving a text message pertaining to the conversation at the communication device; and
performing a text-to-voice media translation of the received text message; and
automatically rendering the translated voice media.

43. The application of claim 34, further comprising:
receiving a photo or image pertaining to the conversation at the communication device; and
automatically rendering the photo or image when the interrupt mode is activated for the conversation.

44. The application of claim 34, further comprising:
receiving a video message pertaining to the conversation at the communication device; and
automatically rendering the video message when the interrupt mode is activated for the conversation.

45. The application of claim 34, further configured to:
receive a plurality of voice messages for rendering in the interrupt mode;
queue the plurality of voice messages for rendering in the interrupt mode; and
automatically render the voice messages in the queue in the interrupt mode.

46. The application of claim 45, further configured to automatically render the queued voice messages using one of the following:
(i) first-in, first out;
(ii) by conversation priority; or
(iii) by sender priority.

47. The application of claim 34, wherein the application is a Push-To-Talk (PTT) application and the received voice message is a PTT message.

48. The application of claim 34, wherein the application is further configured to transmit a reply message in response to the automatic rendering of the received voice message in the interrupt mode.

49. The application of claim 34, wherein the application is further configured to forward the received voice message to a second rendering device for rendering on the second communication device.

50. The application of claim 34, wherein the application is further configured to activate the interrupt mode for a plurality of conversations.

51. An application embedded in a non-transitory computer readable medium and intended to run on a communication device configured to be connected to a network, the application configured to:
automatically render a received voice message in an interrupt mode when:
(i) the application is closed when the voice message is received; and
(ii) the interrupt mode has been designated for a sender of the voice message.

52. The application of claim 51, further configured to store voice media associated with the received voice message on the communication device as the voice media is received over the network.

53. The application of claim 51, wherein automatically rendering the received voice message in the interrupt mode further comprises progressively rendering voice media associated with the received voice message as the voice media is progressively received at the communication device.

54. The application of claim 51, wherein automatically rendering the received voice message in the interrupt mode further comprises:
receiving voice media associated with the voice message at the communication device;
storing the voice media associated with the voice messages on the communication device; and
automatically rendering the received voice message after the voice media associated with the voice message is received and stored on the communication device.

55. The application of claim 51, wherein the voice message blares out of a speaker associated with the communication device when automatically rendered in the interrupt mode.

56. The application of claim 51, wherein the voice message blares out of a headset speaker coupled to the communication device when automatically rendered in the interrupt mode.

57. The application of claim 51, wherein automatically rendering the received voice message in the interrupt mode further comprises:
performing a voice-to-text media translation of voice media included in the received voice message; and
automatically rendering the translated text media.

58. The application of claim 51, further comprising:
receiving a text message pertaining to the conversation at the communication device; and
automatically rendering the text message when the interrupt mode is activated for the conversation.

59. The application of claim 51, further comprising:
receiving a text message pertaining to the conversation at the communication device; and
performing a text-to-voice media translation of the received text message; and
automatically rendering the translated voice media.

60. The application of claim 51, further comprising:
receiving a photo or image pertaining to the conversation at the communication device; and
automatically rendering the photo or image when the interrupt mode is activated for the conversation.

61. The application of claim 51, further comprising:
receiving a video message pertaining to the conversation at the communication device; and
automatically rendering the video message when the interrupt mode is activated for the conversation.

62. The application of claim 51, further configured to:
receive a plurality of voice messages for rendering in the interrupt mode;
queue the plurality of voice messages for rendering in the interrupt mode; and
automatically render the voice messages in the queue in the interrupt mode.

63. The application of claim 62, further configured to automatically render the queued voice messages using one of the following:
(i) first-in, first out;
(ii) by conversation priority; or
(iii) by sender priority.

64. The application of claim 51, wherein the application is a Push-To-Talk (PTT) application and the received voice message is a PTT message.

65. The application of claim 51, wherein the application is further configured to transmit a reply message in response to the automatic rendering of the received voice message in the interrupt mode.

66. The application of claim 51, wherein the application is further configured to forward the received voice message to a second rendering device for rendering on the second communication device.
